(19) United States
(12) Patent Application Publication
(10) Pub. No.: US 2026/0003997 A1
(43) Pub. Date: Jan. 1, 2026

(54) USER CONSENT MANAGEMENT AND COORDINATION

(71) Applicant: Twilio Inc., San Francisco, CA (US)

(72) Inventors: Aaron Klish, San Francisco, CA (US); Jayakrishnan Nair, San Francisco, CA (US); Anand Ramakrishnan, San Francisco, CA (US); Atit Shah, San Francisco, CA (US); Emma Sims, San Francisco, CA (US)

(21) Appl. No.: 18/759,009

(22) Filed: Jun. 28, 2024

(51) Int. Cl. G06F 21/62

(52) U.S. Cl. CPC G06F 21/6245

(57) ABSTRACT

Various embodiments described herein support or provide operations for facilitating consent management and compliance with user consent preferences across multiple platforms. Specifically, a request is received for transmitting data to a destination. The data is associated with a consent preference. A consent preference category assigned to the destination is identified. In response to the determining the consent preference associated with the data corresponding to the consent preference category, the data is transmitted to the destination.

### TECHNICAL FIELD

The present disclosure generally relates to data management. More particularly, various embodiments described herein provide for systems, methods, techniques, instruction sequences, and devices that facilitate consent management and compliance with user consent preferences across multiple platforms.

### BACKGROUND

In the realm of data processing, managing user consent has become increasingly complex due to the proliferation of digital platforms and the diverse regulations governing data privacy. Organizations often face challenges in accurately tracking and applying user consent preferences across various systems and applications. This complexity is compounded by the dynamic nature of consent, where users can change their preferences at any time, necessitating updates across all affected platforms. Additionally, the global landscape of data privacy laws continues to evolve, requiring systems to adapt to new legal standards while maintaining operational efficiency and data integrity. The coordination of these elements within existing data architectures presents ongoing challenges for entities that handle personal data.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system that facilitates consent management and compliance with user consent preferences across multiple platforms, according to various embodiments of the present disclosure.

FIG. 3 is a flowchart illustrating an example method for facilitating consent management and compliance with user consent preferences across multiple platforms, according to various embodiments of the present disclosure.

FIG. 4 is a flowchart illustrating an example method for facilitating consent management and compliance with user consent preferences across multiple platforms, according to various embodiments of the present disclosure.

FIG. 5 is a flowchart illustrating an example method for facilitating consent management and compliance with user consent preferences across multiple platforms, according to various embodiments of the present disclosure.

FIG. 6 is a flowchart illustrating an example method for facilitating consent management and compliance with user consent preferences across multiple platforms, according to various embodiments of the present disclosure.

FIG. 7 is a block diagram illustrating a representative software architecture, which may be used in conjunction with various hardware architectures herein described, according to various embodiments of the present disclosure.

FIG. 8 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments include systems, methods, and non-transitory computer-readable media that facilitate consent management and compliance with user consent preferences across multiple platforms, according to various embodiments of the present disclosure. In today's interconnected digital environment, managing user consent across various platforms presents a significant challenge. Various embodiments involve addressing this challenge by providing a comprehensive solution for synchronizing and enforcing user consent preferences across multiple data processing platforms in real-time. Under this approach, organizations can efficiently adhere to user preferences and regulatory requirements, thereby maintaining trust and compliance.

Various embodiments involve the handling of several aspects of consent management and coordination by a data management system:

Consent Acquisition: This aspect involves gathering user consent preferences. A data management system operates through user interfaces such as webpages or mobile apps, where users can specify their consent preferences regarding how their data is used or shared. The system captures these preferences and accurately records them for downstream processing.

Consent Storage: After collecting user consent preferences, the data management system stores them in a database designed for secure consent records storage. The database makes the records readily accessible for querying and updates. It acts as the central repository for all consent-related information, ensuring that data is consistently available for synchronization and compliance checks.

Consent Synchronization: Changes in user consent are reflected across all platforms (e.g., destinations) that access or process the user's data. The data management system propagates updates throughout the system, ensuring that all data use remains in line with the latest user preferences. This synchronization can be performed in real-time and is vital for maintaining the integrity of consent across diverse systems and applications.

Notification: This aspect involves communication with users regarding any changes in data usage policies or to confirm or update their consent preferences. The data management system can generate and transmit notifications through various channels, such as email, SMS, or in-app notifications. It ensures that users are kept informed about how their data is being used and allows them to update their preferences if necessary.

Compliance Verification: This aspect involves monitoring the use of data across systems to ensure it aligns with user consent and complies with relevant data protection laws. The data management system can perform regular checks and audits to detect discrepancies or violations, providing reports and alerts to help organizations promptly address compliance issues.

Together, these aspects of the consent management and coordination mechanism form a comprehensive system designed to manage user consent effectively. Various embodiments tackle several challenges, including the need for real-time consent updates, maintaining compliance with diverse and evolving data protection regulations, and managing user preferences across multiple platforms. A robust framework is offered for organizations to manage user consent more effectively. By automating the synchronization of consent preferences and ensuring compliance across all data usage points, organizations can reduce the risk of data breaches and non-compliance penalties and enhance user trust by adhering to their data preferences consistently and transparently.

In various embodiments, the data management system allows customer entities (e.g., businesses, customers) to define categories of consent based on specific criteria or purposes and obtain consent for each of the categories from users. This categorization helps organizations manage and track various types of consent they receive from users regarding the use of their personal data or communication preferences. For example, the system allows customer entities to create categories such as “Marketing Consent,” “Transactional Consent,” “Preferences Consent,” or any other relevant categories based on their specific use case or regulatory requirements. Within each category, customer entities can define the scope and purpose of consent, along with any associated preferences or restrictions. By categorizing consent, organizations can better organize and manage their user consent data, ensure compliance with relevant regulations such as General Data Protection Regulation (GDPR) or California Consumer Privacy Act (CCPA), and tailor their data use and communication strategies to align with users' preferences. The data management system's support for defining categories of user consent provides customer entities with greater flexibility and control over how they handle and utilize consent within their applications or communication workflows.

In various embodiments, a data management system receives a request to transmit data to a destination. A destination can refer to any external platform or tool where data is transmitted. The data management system collects and manages customer data from various sources and routes that data to different destinations for analysis, marketing, or other purposes. Destinations can include analytics platforms, customer relationship management (CRM) systems, email marketing services, or any other tool or platform that benefits from the data collected by the data management system. The data associated with the request can include a consent preference. Consent preferences allow individuals to customize their communication experience and control how their personal data is used, ensuring that their privacy and preferences are respected by organizations. Examples (types) of consent preferences include the following, without limitations: preference for how personal data is shared with third parties for marketing or analytical purposes, including opt-in or opt-out options for data sharing; preference for receiving communication via email, SMS, phone calls, or physical mail; preference for the frequency of communication, such as daily, weekly, monthly, or only on special occasions; preference for the type of content received, such as newsletters, promotional offers, product updates, or informational content; preference for the level of personalization in communications, including tailored recommendations, personalized offers, or generic messages; preference for privacy settings related to data collection, tracking, and profiling, including granular controls over cookies, tracking pixels, and other tracking technologies.

In various embodiments, the data management system identifies a consent preference category assigned to the destination. Consent preference categories can be configured by a customer entity associated with the request. Consent preference categories can be configured based on content type, frequency of communication, language, personalization, data sharing, consent management, privacy settings, geographic targeting, and product or service preferences.

In various embodiments, the data management system determines that the consent preference associated with the data corresponds to (or maps to) one or more of the consent preference categories assigned to the destination. The data management system transmits the data to the destination based on (or in response to) the determining of the consent preference. In various embodiments, if data is mapped to one or more consent preference categories, customer entities can configure the system to allow: 1. data be sent only if users consent to all categories; 2. data be sent if users consent to any one of the categories. By ensuring that data adheres to the consent preference categories assigned to the destination, businesses can maintain compliance with data regulations (e.g., GDPR) while delivering targeted audiences, fostering trust and integrity in data management practices.

In various embodiments, there are conditions that need to be met before delivering data to destinations. Specifically, the data management system determines that the data associated with the request corresponds to an event type (e.g., enter events, exit events) of a predefined service. The event type corresponds to one or more conditions that affect the transmission to the requested destination. An example condition can correspond to a change of a trait value in a user profile associated with the data in the request. Another example of a condition can correspond to a change of consent preference made by a user associated with the data in the request. In various embodiments, a condition can refer to a user cohort condition or a group condition. The data management system allows the configuration (or building) of a user cohort. A user can enter or exit the cohort based on satisfying a user cohort condition. A user cohort can refer to a group of users who share common characteristics or experiences within a specified time frame.

In various embodiments, upon determining that one or more conditions (e.g., user cohort conditions, group conditions) are satisfied and that the consent preference corresponds to the consent preference category, the data management system can transmit the data to the destination, as requested.

In various embodiments, the data management system identifies a user profile associated with the user based on the data in the request. A user profile can include a variety of data points and attributes that provide a comprehensive understanding of an individual user. For example, a user profile can include a user identifier, age, gender, location, language preferences, and other relevant demographic details. An example user profile can also include consent preferences (e.g., opt-in or opt-out preferences for data collection and marketing communications), user traits (e.g., attributes assigned to the user based on their behavior, preferences, or other criteria defined by the business), user behavioral data (e.g., interaction with webpages, page views, clicks), event history (e.g., sign-ups, purchases, subscriptions), purchase history, engagement metrics (e.g., session duration, frequency of visits), etc.

User traits, in particular, encompass various aspects such as demographic information, behavioral patterns, preferences, interests, past interactions, and predicted future interactions. In a profile, user traits provide insights into who the user is, what they like, how they behave, and what they might be interested in. Organizations can collect and analyze user traits to personalize experiences, target marketing efforts, recommend relevant content, and tailor products or services to meet individual user needs, etc.

In various embodiments, the data management system determines that the consent preference associated with the request is different from a current consent preference of the same data type in the user profile. A consent preference can apply to one or more data types depending on the context and the regulations in place. For example, in the realm of data privacy and protection, consent preferences can apply to various types (or categories) of personal data such as basic personal information, sensitive personal information, biometric data, location data, behavioral data, genetic data, etc.

In response to determining that the consent preference is different, the data management system determines that the condition corresponding to a change of consent preference is satisfied. In response to determining that the condition corresponding to a change of consent preference is satisfied and that the consent preference corresponds to the consent preference category, the data management system can transmit the data to the requested destination.

In various embodiments, the data management system receives (or collects) consent preferences as user inputs via client devices (e.g., smartphones, tablets, computers, wearable devices, IoT devices). The data management system identifies a user profile based on a device identifier associated with a device, and saves the consent preference in the user profile. The consent preference can be associated with a timestamp indicating a time when the consent preference is received via the device. In various embodiments, a user profile can be identified based on a number of identifiers, including without limitation, email addresses, phone numbers, user identifiers, login IDs, device identifiers, etc.

In various embodiments, the data management system determines that the consent preference is different from a consent preference of the same data type already included in the user profile, indicating a change to the current preference. The data management system updates the consent preference of data associated with the same data type based on the consent preference associated with the request.

Reference will now be made in detail to embodiments of the present disclosure, examples of which are illustrated in the appended drawings. The present disclosure may, however, be embodied in many different forms and should not be construed as being limited to the embodiments set forth herein.

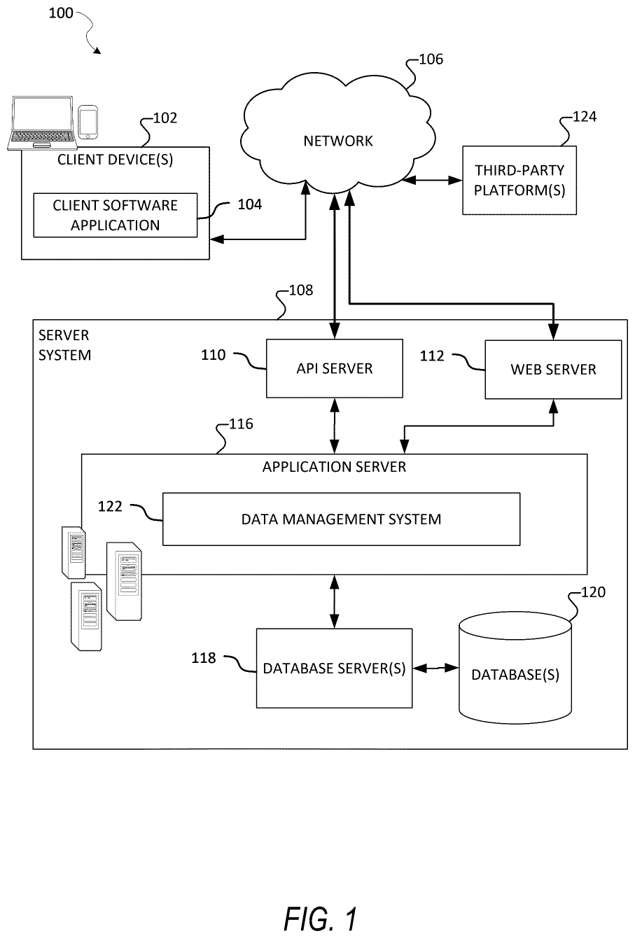

FIG. 1 is a block diagram showing an example data system 100 that includes a data management system 122 (also referred to as system 122), according to various embodiments of the present disclosure. By including the data management system 122, the data system 100 can facilitate consent management and compliance with user consent preferences across multiple platforms. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the data management system 122 may extract user data from one or more third-party platforms (e.g., third-party social media platforms). The extracted data may be open-source poster data associated with targeted influencers on the one or more third-party platforms 124 and may include user profile data, activity data, and media posted (either created and/or shared) by the one or more influencers. The media (or media data) include text, image, video, audio, and metadata. Example metadata may include hashtags and labels.

Through one or more web-based interfaces (e.g., web-based user interfaces), the web server 112 can support various functionality of the data management system 122 of the application server 116.

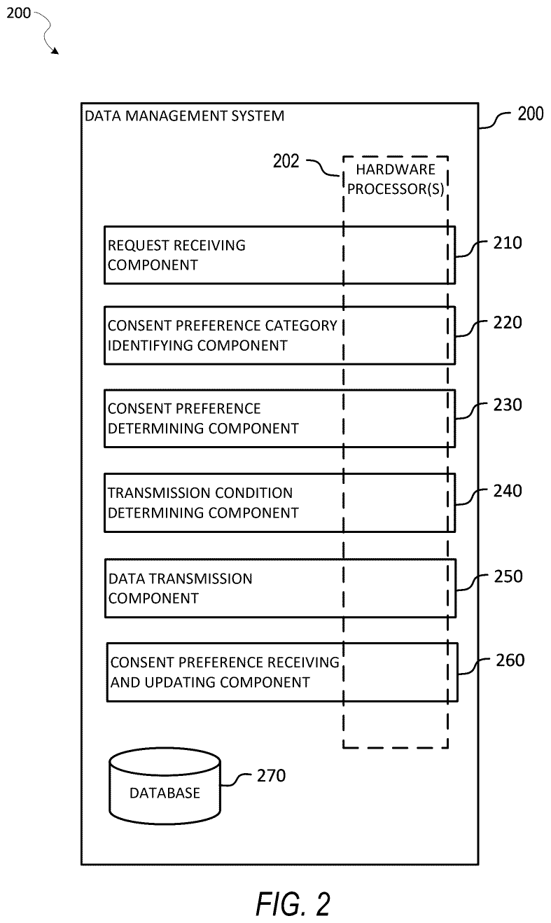

FIG. 2 is a block diagram illustrating an example data management system 200 that facilitates consent management and compliance with user consent preferences across multiple platforms, according to various embodiments of the present disclosure. For some embodiments, the data management system 200 represents an example of the data management system 122 described with respect to FIG. 1. As shown, the data management system 200 comprises a request receiving component 210, a consent preference category identifying component 220, a consent preference determining component 230, a transmission condition determining component 240, a data transmission component 250, a consent preference receiving and updating component 260. According to various embodiments, one or more of the request receiving component 210, the consent preference category identifying component 220, the consent preference determining component 230, the transmission condition determining component 240, the data transmission component 250, and a consent preference receiving and updating component 260 are implemented by one or more hardware processors 202. Data generated by one or more of the request receiving component 210, the consent preference category identifying component 220, the consent preference determining component 230, the transmission condition determining component 240, the data transmission component 250, and the consent preference receiving and updating component 260 may be stored in a database (or datastore) 270 of the data management system 200.

The request receiving component 210 is configured to receive a request to transmit data to a destination. The data is associated with a consent preference. Consent preferences allow individuals to customize their communication experience and control how their personal data is used, ensuring that their privacy and preferences are respected by organizations.

The consent preference category identifying component 220 is configured to identify a consent preference category assigned to the destination. Consent preference categories can be configured based on content type, frequency of communication, language, personalization, data sharing, consent management, privacy settings, geographic targeting, and product or service preferences.

The consent preference determining component 230 is configured to determine that a consent preference in a request corresponds to (or maps to) one of the consent preference categories assigned to the destination. Consent preference categories can be configured (or defined) by a customer entity associated with the request. In various embodiments, a customer entity can generate a mapping between one or more consent preference categories and a destination. The consent preference determining component 230 is configured to determine if the consent preference in the request belongs to a consent preference category mapped to a requested destination. By ensuring that data adheres to the consent preference categories assigned to the destination, businesses can maintain compliance with data regulations (e.g., GDPR, CCPA) while delivering targeted audiences, fostering trust and integrity in data management practices.

The transmission condition determining component 240 is configured to determine if one or more conditions need to be met before delivering data to destinations. In particular, the transmission condition determining component 240 is configured to determine that the data associated with the request corresponds to an event type (e.g., enter events, exit events) of a predefined service. The event type corresponds to one or more conditions that affect the transmission to the requested destination. An example condition can correspond to a change of a trait value in a user profile associated with the data in the request. Another example of a condition can correspond to a change of consent preference made by a user associated with the data in the request.

The data transmission component 250 is configured to transmit the data to the requested destination upon determining that one or more conditions are satisfied.

The consent preference receiving and updating component 260 is configured to receive (or collect) consent preferences as user inputs via various types of client devices (e.g., smartphones, tablets, computers, wearable devices, IoT devices). The consent preference receiving and updating component 260 is configured to identify user profiles based on device identifiers associated with the client devices via which the consent preferences were received. Then, the consent preferences are either saved or updated in the user profiles depending on whether the profiles already include previously recorded preferences for the same data type. A consent preference can be associated with a timestamp indicating when the consent preference is received (or collected) via a device. In various embodiments, changes to consent preferences can also be sent to destinations. The data management systems can maintain a complete history (e.g., audit history) of all the changes made to consent preferences in a user profile. In various embodiments, consent preferences can be reconstructed at any point in time based on data included in a given user profile.

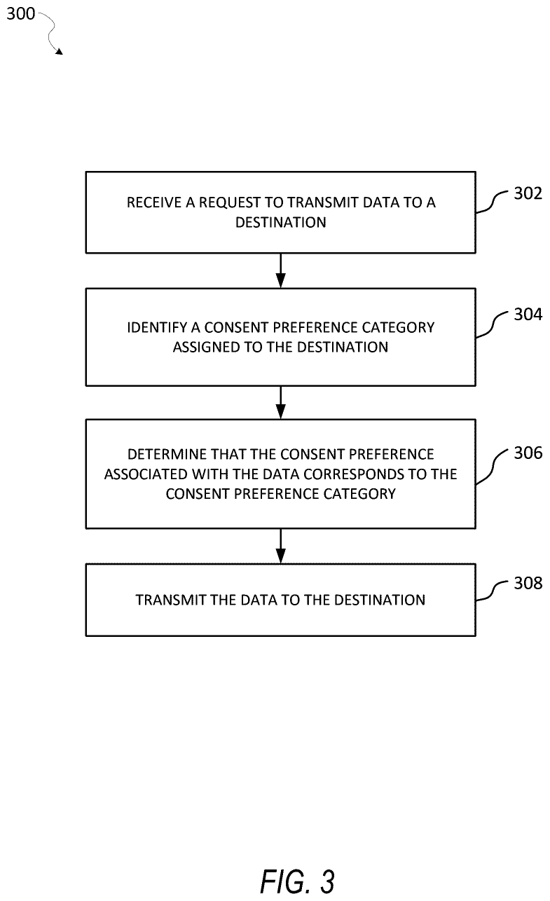

FIG. 3 is a flowchart illustrating an example method 300 for facilitating consent management and compliance with user consent preferences across multiple platforms, according to various embodiments of the present disclosure. It will be understood that example methods described herein may be performed by a machine in accordance with some embodiments. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor receives a request to transmit data to a destination. The data is associated with a consent preference. Consent preferences allow individuals to customize their communication experience and control how their personal data is used, ensuring that their privacy and preferences are respected by organizations. A destination can refer to any external platform or tool where data is transmitted.

At operation 304, a processor identifies a consent preference category assigned to the destination. Consent preference categories can be configured based on content type, frequency of communication, language, personalization, data sharing, consent management, privacy settings, geographic targeting, and product or service preferences. In various embodiments, customer entities (e.g., businesses, customers) can define categories of consent preference based on specific criteria or purposes and obtain consent for each of the categories from users. This categorization helps customer entities manage and track various types of consent they receive from users regarding the use of their personal data or communication preferences.

At operation 306, a processor determines that the consent preference associated with the data corresponds to (or maps to) the consent preference category. A customer entity can configure (or define) consent preference categories and can assign one or more consent preference categories to a destination. By ensuring that data adheres to the consent preference categories assigned to the destination, businesses can maintain compliance with data regulations (e.g., GDPR, CCPA) while delivering targeted audiences, fostering trust and integrity in data management practices.

At operation 308, a processor transmits the data to the destination at least based on the determination that the consent preference associated with the data corresponds to (or maps to) the consent preference category assigned to the destination. In various embodiments, changes made to the consent preference can be transmitted to the destination.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 308 or, alternatively, form part of one or more of operations 302 through 308.

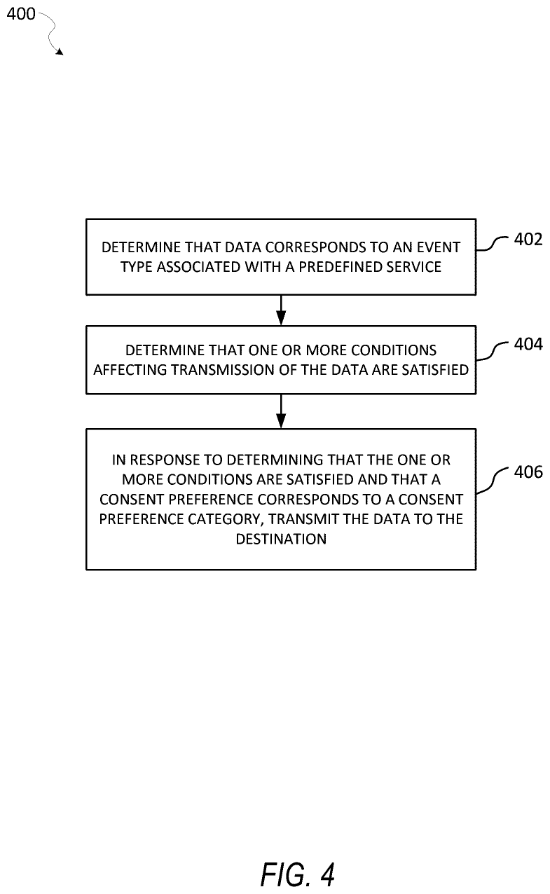

FIG. 4 is a flowchart illustrating an example method 400 for facilitating consent management and compliance with user consent preferences across multiple platforms, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

At operation 402, a processor determines that data corresponds to an event type (e.g., enter events, exit events) associated with a predefined service. An event type can correspond to one or more conditions that affect the transmission to the requested destination. For example, enter events can only be sent to a specific destination when the user profile satisfies a definition associated with a service. In another example, events associated with a particular service can only be sent when there is a change to a trait value in the associated user profile.

At operation 404, a processor determines that one or more conditions that affect the transmission of the data are satisfied. A condition can refer to a user cohort condition or a group condition. The data management system allows the configuration (or building) of a user cohort. A user can enter or exit the cohort based on satisfying a user cohort condition. A user cohort can refer to a group of users who share common characteristics or experiences within a specified time frame.

At operation 406, a processor transmits the data to the destination in response to determining that the one or more conditions are satisfied and that a consent preference corresponds to a consent preference category.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 406 or, alternatively, form part of one or more of operations 402 through 406.

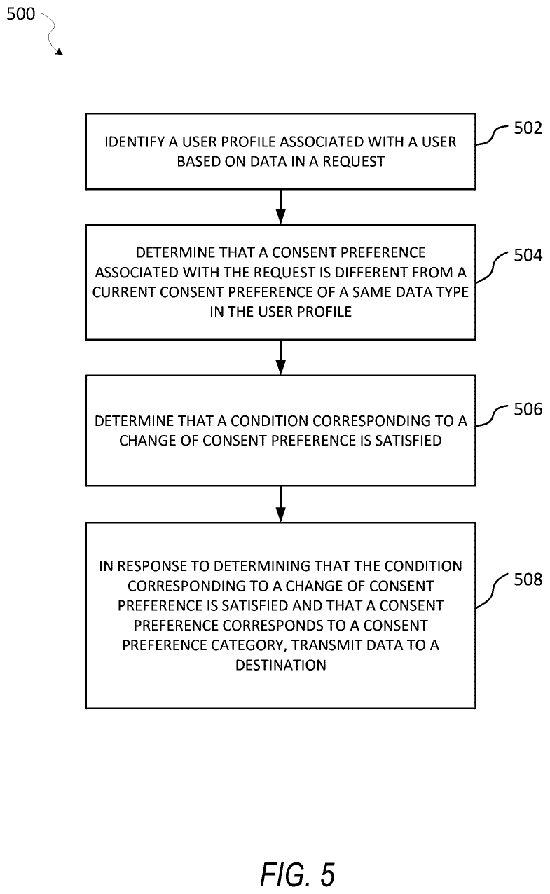

FIG. 5 is a flowchart illustrating an example method 500 for facilitating consent management and compliance with user consent preferences across multiple platforms, according to various embodiments of the present disclosure. It will be understood that example methods described herein may be performed by a machine in accordance with some embodiments. For example, method 500 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 500 can be performed dependently or independently from operations in method 300 and method 400.

At operation 502, a processor identifies a user profile associated with a user based on data in a request. A user profile can include a variety of data points and attributes that provide a comprehensive understanding of an individual user. For example, a user profile can include a user identifier, age, gender, location, language preferences, and other relevant demographic details. An example user profile can also include consent preferences (e.g., opt-in or opt-out preferences for data collection and marketing communications), user traits (e.g., attributes assigned to the user based on their behavior, preferences, or other criteria defined by the business), user behavioral data (e.g., interaction with webpages, page views, clicks), event history (e.g., sign-ups, purchases, subscriptions), purchase history, engagement metrics (e.g., session duration, frequency of visits), etc.

At operation 504, a processor determines that a consent preference associated with the request is different from a current consent preference of the same data type in the user profile, indicating a change of a consent preference. For example, a user can initially agree to share location data with a mobile app for personalized recommendations. However, after using the app for some time, the user becomes concerned about privacy and decides to revoke the location-sharing consent.

At operation 506, a processor determines that a condition corresponding to a change of consent preference is satisfied.

At operation 508, a processor transmits the data to the destination in response to determining that the condition corresponding to a change of consent preference is satisfied and that a consent preference corresponds to a consent preference category.

Though not illustrated, method 500 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 502 through 508 or, alternatively, form part of one or more of operations 502 through 508.

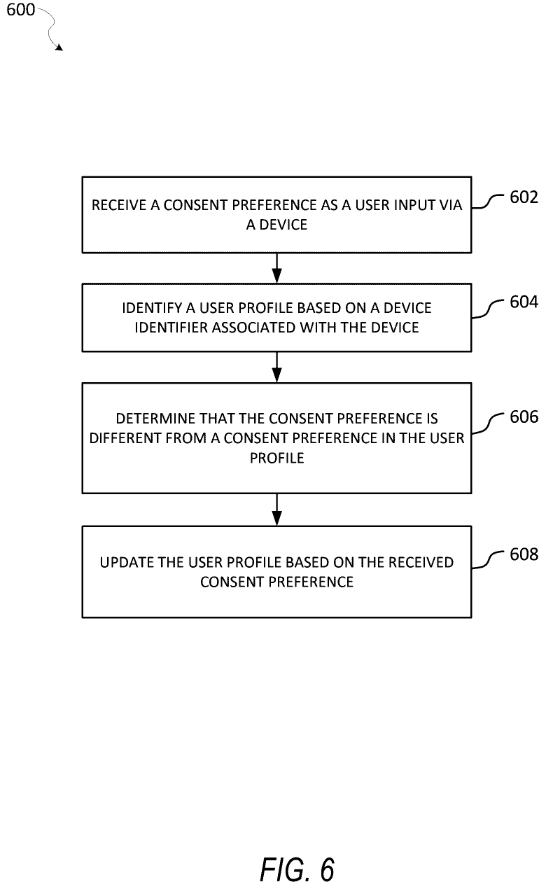

FIG. 6 is a flowchart illustrating an example method 600 for facilitating consent management and compliance with user consent preferences across multiple platforms, according to various embodiments of the present disclosure. It will be understood that example methods described herein may be performed by a machine in accordance with some embodiments. For example, method 600 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 600 may be represented by executable instructions that, when executed by a processor of a computing device, cause the computing device to perform method 600. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 600 can be performed dependently or independently from operations in method 300, method 400 and method 500.

At operation 602, a processor receives a consent preference as a user input via a device (e.g., smartphones, tablets, computers, wearable devices, IoT devices).

At operation 604, a processor identifies a user profile based on a device identifier associated with the device.

At operation 606, a processor determines that the consent preference is different from a consent preference of the same data type in the user profile.

At operation 608, a processor updates the user profile based on the received consent preference. Updating user profiles enables other platforms and/or systems with access to the profiles to retrieve the latest data, thus ensuring synchronization and data integrity across multiple platforms.

Though not illustrated, method 600 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 602 through 608 or, alternatively, form part of one or more of operations 602 through 608.

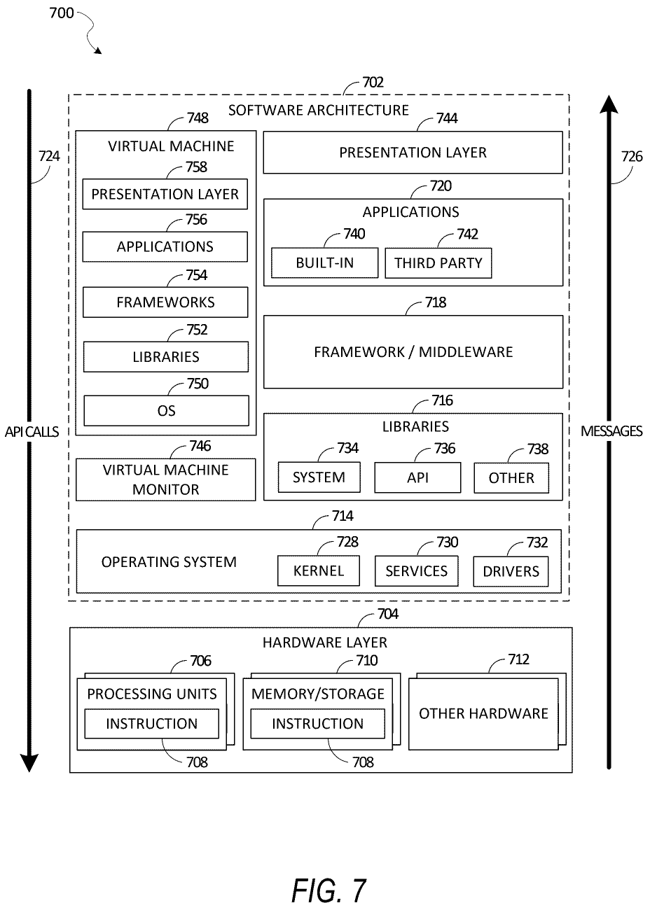

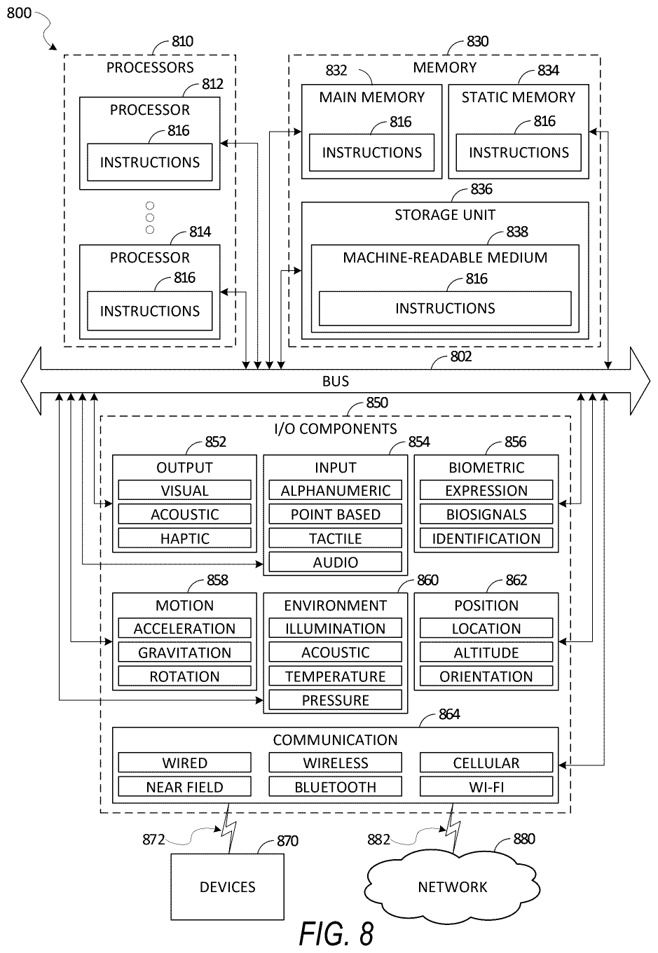

FIG. 7 is a block diagram illustrating an example of a software architecture 702 that may be installed on a machine, according to some example embodiments. FIG. 7 is merely a non-limiting example of a software architecture, and it will be appreciated that many other architectures may be implemented to facilitate the functionality described herein. The software architecture 702 may be executing on hardware such as a machine 800 of FIG. 8 that includes, among other things, processors 810, memory 830, and input/output (I/O) components 870. A representative hardware layer 704 is illustrated and can represent, for example, the machine 800 of FIG. 8. The representative hardware layer 704 comprises one or more processing units 706 having associated executable instructions 708. The executable instructions 708 represent the executable instructions of the software architecture 702. The hardware layer 704 also includes memory or storage modules 710, which also have the executable instructions 708. The hardware layer 704 may also comprise other hardware 712, which represents any other hardware of the hardware layer 704, such as the other hardware illustrated as part of the machine 800.

In the example architecture of FIG. 7, the software architecture 702 may be conceptualized as a stack of layers, where each layer provides particular functionality. For example, the software architecture 702 may include layers such as an operating system 714, libraries 716, frameworks/middleware 718, applications 720, and a presentation layer 744. Operationally, the applications 720 or other components within the layers may invoke API calls 724 through the software stack and receive a response, returned values, and so forth (illustrated as messages 726) in response to the API calls 724. The layers illustrated are representative in nature, and not all software architectures have all layers. For example, some mobile or special-purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than by interfacing directly with the underlying operating system 714 functionality (e.g., kernel 728, services 730, or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be utilized by the applications 720 or other software components/modules. For example, the frameworks 718 may provide various graphical user interface functions, high-level resource management, high-level location services, and so forth. The frameworks 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a home application, a contacts application, a browser application, a book reader application, a location application, a media application, a messaging application, or a game application.

The third-party applications 742 may include any of the built-in applications 740, as well as a broad assortment of other applications. In a specific example, the third-party applications 742 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 742 may invoke the API calls 724 provided by the mobile operating system such as the operating system 714 to facilitate functionality described herein.

The applications 720 may utilize built-in operating system functions (e.g., kernel 728, services 730, or drivers 732), libraries (e.g., system libraries 734, API libraries 736, and other libraries 738), or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with the user.

Some software architectures utilize virtual machines. In the example of FIG. 7, this is illustrated by a virtual machine 748. The virtual machine 748 creates a software environment where applications/modules can execute as if they were executing on a hardware machine (e.g., the machine 600 of FIG. 6). The virtual machine 748 is hosted by a host operating system (e.g., the operating system 714) and typically, although not always, has a virtual machine monitor 746, which manages the operation of the virtual machine 748 as well as the interface with the host operating system (e.g., the operating system 714). A software architecture executes within the virtual machine 748, such as an operating system 750, libraries 752, frameworks 754, applications 756, or a presentation layer 758. These layers of software architecture executing within the virtual machine 748 can be the same as corresponding layers previously described or may be different.

FIG. 8 illustrates a diagrammatic representation of a machine 800 in the form of a computer system within which a set of instructions may be executed for causing the machine 800 to perform any one or more of the methodologies discussed herein, according to an embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the method 300 described above with respect to FIG. 3, the method 400 described above with respect to FIG. 4, the method 500 described above with respect to FIG. 5, and the method 600 described above with respect to FIG. 6. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an embodiment, the processors 810 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836 including machine-readable medium 838, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In some examples, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 850 may include biometric components 856, motion components 858, environmental components 860, or position components 862, among a wide array of other components. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 800 including processors 810), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 800, but deployed across a number of machines 800. In some example embodiments, the processors 810 or processor-implemented modules are located in a single geographic location (e.g., within a home environment, an office environment, or a server farm). In other example embodiments, the processors or processor-implemented modules are distributed across a number of geographic locations.

The various memories (i.e., 830, 832, 834, and/or the memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 880 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
receiving a request to transmit data to a destination, the data being associated with a consent preference;
identifying a consent preference category assigned to the destination;
determining that the consent preference associated with the data corresponds to the consent preference category; and
in response to the determining of the consent preference, transmitting the data to the destination.

2. The method of claim 1, wherein the consent preference category is configured by a customer entity associated with the request.

3. The method of claim 1, comprising:
determining that the data corresponds to an event type associated with a predefined service, the event type corresponding to a condition that affects transmission of one or more events of the event type to the destination.

4. The method of claim 3, comprising:
determining that the condition is satisfied; and
in response to determining that the condition is satisfied and that the consent preference corresponds to the consent preference category, transmitting the data to the destination.

5. The method of claim 3, wherein the condition corresponds to a change of a trait value in a user profile associated with the data in the request, and wherein the condition corresponds to a user cohort condition or a group condition.

6. The method of claim 3, wherein the condition corresponds to a change of consent preference by a user associated with the data in the request.

7. The method of claim 6, comprising:
identifying a user profile associated with the user based on the data in the request;
determining that the consent preference is different from a current consent preference of a same data type in the user profile; and
in response to determining that the consent preference is different, determining that the condition corresponding to a change of consent preference is satisfied.

8. The method of claim 7, comprising:
In response to determining that the condition corresponding to a change of consent preference is satisfied and that the consent preference corresponds to the consent preference category, transmitting the data to the destination.

9. The method of claim 1, comprising:
receiving the consent preference as a user input via a device;
identifying a user profile based on a device identifier associated with the device; and
saving the consent preference in the user profile, the consent preference being associated with a timestamp indicating a time when the consent preference is received via the device.

10. The method of claim 9, comprising:
determining that the consent preference is different from a consent preference of a same data type in the user profile; and
updating the consent preference of data associated with the same data type based on the consent preference.

11. A system comprising:
one or more hardware processors; and
at least one machine-storage medium for storing instructions that, when executed by the one or more hardware processors, cause the one or more hardware processors to perform operations comprising:
receiving a request to transmit data to a destination, the data being associated with a consent preference;
identifying a consent preference category assigned to the destination;
determining that the consent preference associated with the data corresponds to the consent preference category; and
in response to the determining of the consent preference, transmitting the data to the destination.

12. The system of claim 11, wherein the consent preference category is configured by a customer entity associated with the request.

13. The system of claim 11, wherein the operations comprise:
determining that the data corresponds to an event type associated with a predefined service, the event type corresponding to a condition that affects transmission of one or more events of the event type to the destination.

14. The system of claim 13, wherein the operations comprise:
determining that the condition is satisfied; and
in response to determining that the condition is satisfied and that the consent preference corresponds to the consent preference category, transmitting the data to the destination.

15. The system of claim 13, wherein the condition corresponds to a change of a trait value in a user profile associated with the data in the request, and wherein the condition corresponds to a user cohort condition or a group condition.

16. The system of claim 13, wherein the condition corresponds to a change of consent preference by a user associated with the data in the request.

17. The system of claim 16, wherein the operations comprise:
identifying a user profile associated with the user based on the data in the request;
determining that the consent preference is different from a current consent preference of a same data type in the user profile; and
in response to determining that the consent preference is different, determining that the condition corresponding to a change of consent preference is satisfied.

18. The system of claim 17, wherein the operations comprise:
In response to determining that the condition corresponding to a change of consent preference is satisfied and that the consent preference corresponds to the consent preference category, transmitting the data to the destination.

19. The system of claim 11, wherein the operations comprise:
receiving the consent preference as a user input via a device;
identifying a user profile based on a device identifier associated with the device; and
saving the consent preference in the user profile, the consent preference being associated with a timestamp indicating a time when the consent preference is received via the device.

20. A machine-storage medium for storing instructions that, when executed by one or more hardware processors, cause the one or more hardware processors to perform operations comprising:
receiving a request to transmit data to a destination, the data being associated with a consent preference;
identifying a consent preference category assigned to the destination;
determining that the consent preference associated with the data corresponds to the consent preference category; and
in response to the determining of the consent preference, transmitting the data to the destination.
